(19) United States
(12) Patent Application Publication
(10) Pub. No.: US 2007/0014046 A1
(43) Pub. Date: Jan. 18, 2007

(54) Spindle motor assembly usable with a hard disk drive

(75) Inventor: Myung-il Kim, Seongnam-si (KR)

Correspondence Address: STANZIONE & KIM, LLP, 919 18TH STREET, N.W., SUITE 440, WASHINGTON, DC, 20006, US

(73) Assignee: SAMSUNG Electronics Co.,Ltd., Suwon-si (KR)

(21) Appl. No.: 11/480,926

(22) Filed: Jul. 6, 2006

(30) Foreign Application Priority Data
Jul. 18, 2005 (KR) 2005-64757

(51) Int. Cl. G11B 17/02

(52) U.S. Cl. 360/99.12

(57) ABSTRACT

A spindle motor assembly usable with a hard disk drive. The spindle motor assembly includes a data storage disc having a center hole, a clamping zone around the center hole, and a data zone provided at an outer portion of the clamping zone, a spindle motor to rotate the disc, the spindle motor including a shaft, a hub coupled to an outer circumference of the shaft, and a supporter disposed at an upper surface of the shaft and having an outer diameter smaller than the hub and extending a predetermined a height above an upper surface of the hub to contact the clamping zone of the disc to support the disc, and a clamping screw inserted into the center hole of the disc and fastened to the spindle motor to press the clamping zone to fix the disc to the supporter. Thus, the disc is fixed to the spindle motor without using a disc clamp or a spacer, and a recording area of the disc is maximized.

### CROSS-REFERENCE TO RELATED APPLICATIONS

This application claims the benefit of Korean Patent Application No. 10-2005-0064757, filed on Jul. 18, 2005, in the Korean Intellectual Property Office, the disclosure of which is incorporated herein in its entirety by reference.

### BACKGROUND OF THE INVENTION

1. Field of the Invention

The present general inventive concept relates to a hard disk drive, and more particularly, to a spindle motor assembly on which to mount a data storage disc and to rotate the same.

2. Description of the Related Art

A hard disk drive (HDD) is a device that includes a read/write head to reproduce (i.e., read) data stored on a data storage disc and/or record data on the data storage disc. The data storage disc is mounted on a spindle motor and is rotated thereby. The read/write head is moved to a desired position above a surface of the data storage disc by an actuator in order to read/write data therefrom.

FIG. 1 is an exploded perspective view illustrating a conventional spindle motor assembly, and FIG. 2 is a sectional view of the conventional spindle motor assembly of FIG. 1.

Referring to FIGS. 1 and 2, the conventional spindle motor assembly includes a data storage disc 20, a spindle motor 30 for rotating the data storage disc 20, a spacer 40, a disc clamp 50, and a clamping screw 60.

The spindle motor 30 is installed on a base member 10 of the hard disk drive and includes a shaft 32, a stator 36 installed at an outer circumference of the shaft 32, and a rotator 34. The rotator 34 is a hub, and the disc 20 is mounted on an outer circumference of the hub 34. The disc clamp 50 is mounted on the spindle motor 30 to stably support the disc 20 thereon. The spacer 40 is ring-shaped and may be mounted between the disc 20 and the disc clamp 50. The spacer 40 is mounted to correspond to the circumference of the hub 34 of the spindle motor 30.

The disc 20 has a center hole 21 at a center portion thereof into which the hub 34 of the spindle motor 30 is inserted, and a clamping zone 22 of the disc 20 that contacts the spacer 40 or the disc clamp 50 is provided around the center hole 21. A remaining outer portion of the disc 20 except the clamping zone 22 is a data zone 24 to record/reproduce data.

The disc clamp 50 may be fixed to the spindle motor 30 by a clamping screw 60. The disc clamp 50 has a screw hole 53 at a center portion thereof into which the clamping screw 60 is inserted. Additionally, the shaft 32 of the spindle motor 30 has a screw-fastening hole 33 at an upper portion thereof into which the clamping screw 60 is fastened. When fastening the clamping screw 60 into the screw-fastening hole 33, the disc clamp 50 is deformed by the clamping screw 60 and presses the spacer 40 and the disc 20, thereby fixing the disc 20 to the hub 34 of the spindle motor 30. The method of fixing the disc clamp 50 can be used when the shaft 32 is rotated with the hub 34.

The disc clamp 50 can be fixed to the spindle motor 30 using another method. That is, the disc clamp 50 can be fixed to the spindle motor 30 by a plurality of screws (not shown) fastened to the hub 34 of the spindle motor 30. The hub 34 has a plurality of screw-fastening holes 35 at an upper surface thereof into which the plurality of screws are fastened. Additionally, the disc clamp 50 has a plurality of screw holes 55. This fixing method of the disc clamp 50 can be used when only the hub 34 is rotated, and the shaft 32 of the spindle motor 30 is fixed to the base member 10.

However, the conventional spindle motor assembly having the above-described structure uses a large number of parts, thereby complicating an assembly process and increasing the manufacturing cost.

In addition, the conventional spindle motor assembly has a problem in that during the assembly of the spacer 40, the disc clamp 50, and one or more screws (e.g., the screw 60), these parts are likely to contact and damage a surface of the disc 20.

Further, since the disc 20 (glass), the spacer 40 (metal), and the disc clamp 50 (metal) contact each other, a difference in coefficients of thermal expansion causes an amount of thermal expansion therebetween due to a temperature to vary. This difference in thermal expansion causes a drawback in that friction between these parts (the disc 20, the spacer 40, and the disc claim 50) is generated, and particles are produced therebetween.

Furthermore, the conventional spindle motor assembly has a drawback in that a relatively large clamping zone should be provided at a center portion of the disc 20 causing an area of the data zone 24 of the disc to be reduced accordingly.

### SUMMARY OF THE INVENTION

The present general inventive concept provides a spindle motor assembly usable with a hard disk drive and having a structure capable of fixing a disc to a spindle motor without using a disc clamp and maximizing a data recording area of the disc.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a spindle motor assembly usable with a hard disk drive, including a data storage disc having a center hole, a clamping zone around the center hole, and a data zone provided at an outer portion of the clamping zone, a spindle motor to rotate the disc, the spindle motor including a shaft, a hub coupled to an outer circumference of the shaft, and a supporter disposed at an upper surface of the shaft and having an outer diameter smaller than the hub and extending a predetermined height above an upper surface of the hub to contact the clamping zone of the disc to support the disc, and a clamping screw inserted into the center hole of the disc and fastened to the spindle motor to press the clamping zone to fix the disc to the supporter.

The supporter may be formed integrally with the shaft. The supporter may have a screw-fastening hole into which the clamping screw is fastened.

The supporter may be formed to have a ring shape to surround the shaft. In this case, the shaft may have a screw-fastening hole at an upper surface thereof into which the clamping screw is fastened.

An outer diameter of the clamping zone of the disc may be substantially equal to the outer diameter of the supporter, and an outer diameter of a head portion of the clamping screw may be substantially equal to the outer diameter of the supporter.

A surface roughness of the clamping zone of the disc may be higher than a surface roughness of the data zone. In this case, the clamping zone of the disc may have a plurality of fine protrusions formed to have a crater shape by a laser beam machining process.

The spindle motor assembly may further include a read/write head movable with respect to the disc by an actuator to access the data zone adjacent to the clamping zone through a space defined between a bottom surface of the disc and the upper surface of the hub.

The disc may further have a parking zone disposed between the clamping zone and the data zone in which the read/write head is parked. In this case, an outer diameter of the parking zone may be less than or equal to the outer diameter of the hub.

According to the embodiments of the present general inventive concept, a disc can be fixed to a spindle motor without using a disc clamp or a spacer, and a recording area of the disc can be maximized.

The foregoing and/or other aspects of the present general inventive concept may also be achieved by providing a spindle motor assembly usable with a hard disk drive, the assembly including a base, a spindle motor including a shaft extending from the base to be rotated with respect to the base, a disc disposed on an upper portion of the shaft and having a center hole, and a fastening member to couple the disc to the upper portion of the shaft through the center hole thereof.

The foregoing and/or other aspects of the present general inventive concept may also be achieved by providing a spindle motor assembly usable with a hard disk drive, the assembly including a supporter, a fastening screw coupled to the supporter, and a disc disposed on the supporter and including a center hole of a predetermined size that corresponds to the fastening screw such the fastening screw couples the disc to the supporter.

The foregoing and/or other aspects of the present general inventive concept may also be achieved by providing a spindle motor assembly usable with a hard disk drive, the assembly including a base, a spindle motor including a shaft extending from the base to be rotated with respect to the base and having an upper portion to support a disc thereon, and a rotator disposed around the spindle motor such that the shaft protrudes a predetermined height above an upper portion of the rotator.

The foregoing and/or other aspects of the present general inventive concept may also be achieved by providing a hard disc usable by a hard disk drive including a center hole portion having a predetermined size that corresponds to a fastening screw.

The foregoing and/or other aspects of the present general inventive concept may also be achieved by providing a hard disk drive, including a housing having base and cover portions, a spindle motor including a shaft extending from the base portion to be rotated with respect to the base portion, a disc disposed on an upper portion of the shaft and having a center hole, and a fastening member to couple the disc to the upper portion of the shaft through the center hole thereof.

The foregoing and/or other aspects of the present general inventive concept may also be achieved by providing a disk drive, including a spindle motor having a shaft connected to the spindle motor and a hub inserted around the shaft and having a stator and a rotator to rotate the shaft, a disc having a first surface to contact the shaft and a second surface, and a connector disposed to contact the second surface of the disk to connect the disk to the shaft.

The foregoing and/or other aspects of the present general inventive concept may also be achieved by providing a method of assembling a hard disk drive including base and cover portions and a spindle motor shaft extending from the base portion, the method including positioning a disc having a center hole on an upper portion of the spindle motor shaft, and fastening a fastening member through the center hole of the disc to couple the disc to the spindle motor shaft such that the disc is fixed between the upper portion of the spindle motor shaft and a head portion of the fastening member.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is an exploded perspective view illustrating a conventional spindle motor assembly of a hard disk drive;

FIG. 2 is a sectional view illustrating the conventional spindle motor assembly of FIG. 1;

FIG. 3 is an exploded perspective view illustrating a hard disk drive with a spindle motor assembly according to an embodiment of the present general inventive concept;

FIG. 4 is a sectional view illustrating the spindle motor assembly of FIG. 3 according to the embodiment of the present general inventive concept;

FIG. 5 is an enlarged perspective view illustrating a clamping zone of a data storage disc of FIG. 3 according to an embodiment of the present general inventive concept; and

FIG. 6 is a sectional view illustrating a spindle motor assembly according to another embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

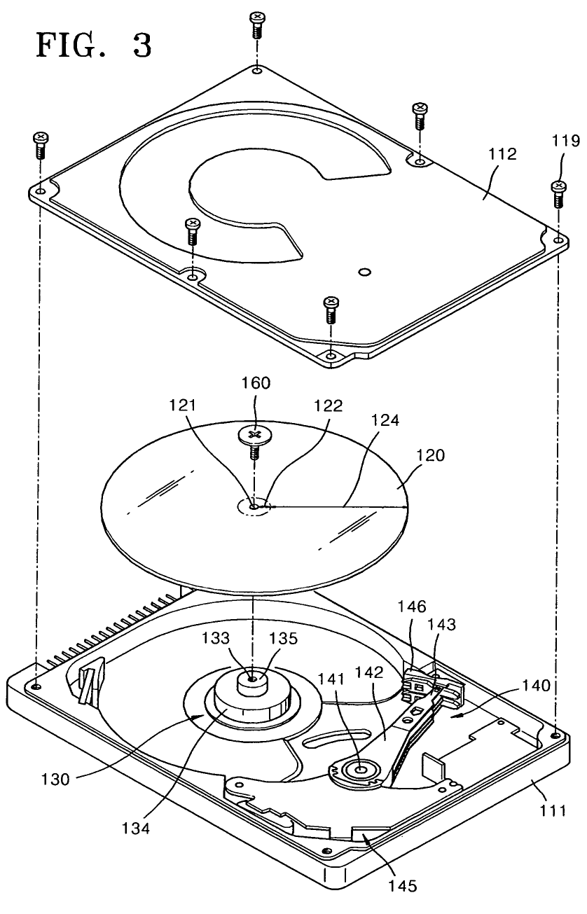

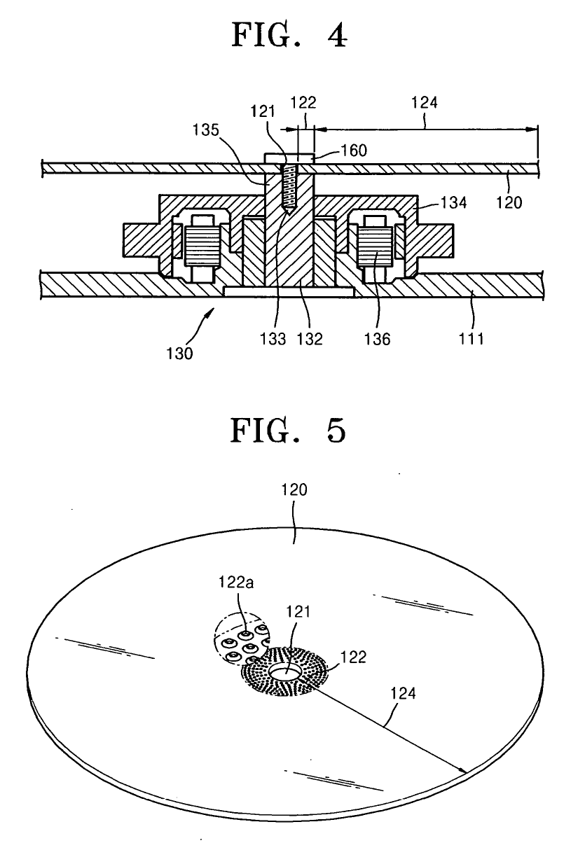

FIG. 3 is an exploded perspective view illustrating a hard disk drive with a spindle motor assembly according to an embodiment of the present general inventive concept, FIG. 4 is a sectional view illustrating the spindle motor assembly of FIG. 3, and FIG. 5 is an enlarged perspective view illustrating a clamping zone of a data storage disc 120 of FIG. 3.

Referring to FIGS. 3 and 4, the hard disk drive includes a base member 111, a spindle motor 130 disposed on the base member 111 to rotate the disc 120 (i.e., a recording medium for data storage) and an actuator 140 to move a read/write head to a desired position above the disc 120 to reproduce and/or record data.

The actuator 140 includes a swing arm 142 rotatably coupled to an actuator pivot 141 installed on the base member 111, a suspension 143 installed at one end of the swing arm 142 to support a slider that biases the read/write head toward a data recording surface of the disc 120, and a voice coil motor (VCM) 145 to rotate the swing arm 142. The voice coil motor 145 is controlled by a servo control system so that the swing arm 142 is rotated in a direction according to Fleming's left-hand rule by an interaction between input electric current of a VCM coil and a magnetic field of a magnet. That is, when the hard disk drive is turned ON and the disc 120 starts to rotate, the voice coil motor 145 moves the swing arm 142 counterclockwise to move the read/write head to a position above the data recording surface of the disc 120. On the other hand, when the hard disk drive is turned OFF and the disc 120 stops rotating, the voice coil motor 145 moves the swing arm 142 clockwise to move the read/write head away from the data recording surface of the disc 120. At this time, the head is parked on a ramp 146 provided outside of the disc 120.

A cover member 112 is coupled to an upper portion of the base member 111 using a plurality of fastening screws 119. Other fastening members may alternatively be used to couple the cover member 112 to the base member 111. The base member 111 and the cover member 112 house and protect the disc 120, the spindle motor 130, and the actuator 140.

The spindle motor assembly of the present embodiment includes the disc 120, the spindle motor 130 to rotate the disc 120, and a clamping screw 160 to stably fix the disc 120 to the spindle motor 130.

The spindle motor 130 includes a shaft 132, a stator 136, and a rotator 134 installed at an outer circumference of the shaft 132. The rotator 134 can also be called a “hub,” and is rotated together with the shaft 132.

A supporter 135 is provided at an upper portion of the spindle motor 130 (i.e., an upper portion of the shaft 132) to support the disc 120. Specifically, the supporter 135 has an outer diameter that is smaller than that of the hub 134, and protrudes a predetermined height above an upper surface of the hub 134. In a state in which a bottom surface of the disc 120 contacts an upper surface of the supporter 135, the disc 120 is securely fixed to the supporter 135 by the clamping screw 160.

The supporter 135 can be formed by the upper portion of the shaft 132. That is, the upper portion of the shaft 132 extends to the predetermined height above the upper surface of the hub 134, and the upper portion of the shaft 132 serves as the supporter 135. The supporter 135 has a screw-fastening hole 133 at an upper surface thereof that extends downward in the shaft 132 to a predetermined depth. The clamping screw 160 is fastened into the fastening hole 133.

The disc 120 has a center through-hole 121, a clamping zone 122 around the center through-hole 121, and a data zone 124 provided outside of the clamping zone 122.

The clamping screw 160 is inserted into the center through-hole 121 of the disc 120. The clamping zone 122 of the disc 120 is a region that contacts the supporter 135 on one side and a head portion of the clamping screw 160 on the other side. An outer diameter of the clamping zone 122 of the disc 120 may be the same as an outer diameter of the supporter 135. Also, an outer diameter of the head portion of the clamping screw 160 may be the same as the outer diameter of the supporter 135. The clamping zone 122 of the disc 120 is interposed between the supporter 135 and the head portion of the clamping screw 160 to securely fix the disc 120 to the supporter 135 of the spindle motor 130 using the clamping screw 160. That is, when inserting the clamping screw 160 into the center through-hole 121 of the disc 120 and fastening the clamping screw 160 to the screw-fastening hole 133 of the supporter 135, the clamping screw 160 presses the clamping zone 122 of the disc 120, thereby securely fixing the disc 120 to the supporter 135 of the spindle motor 130.

As described above, the spindle motor assembly of the present embodiment can fix the disc 120 to the spindle motor 130 without using a conventional disc clamp and a spacer. The clamping zone 122 is provided in the disc 120, and can be formed during a manufacturing process of the disc 120.

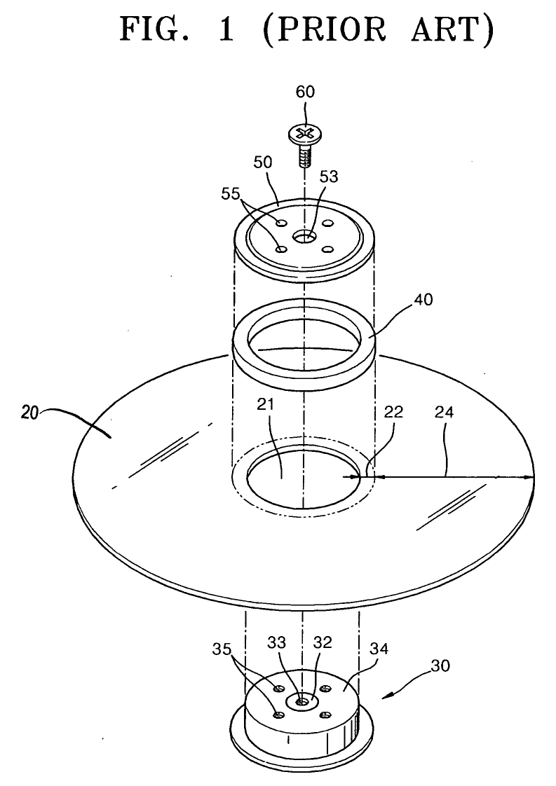

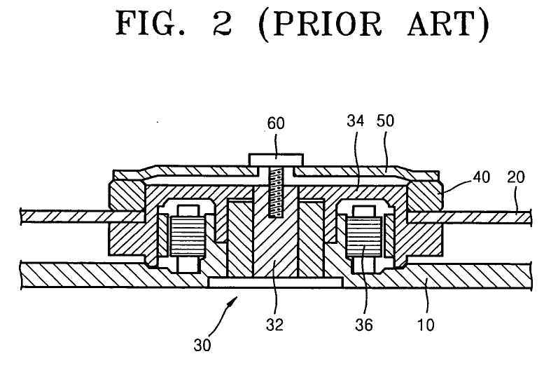

Accordingly, the spindle motor assembly of the present embodiment has a simple structure in comparison with the structure of the conventional spindle motor assembly of FIGS. 1 and 2. Additionally, a number of manufacturing and assembly processes is reduced from those required for the conventional spindle motor assembly. Furthermore, a possibility of damaging the surface of the disc 120 due to friction between parts during the assembly process is reduced, and no particles are generated between parts made of metal.

In addition, the outer diameter of the clamping zone 122 of the disc 120 of the present embodiment is considerably smaller compared to the outer diameter of the clamping zone 22 of the conventional spindle motor assembly (see FIG. 1)so that an area of the data zone 124 provided outside of the clamping zone 122 is enlarged to increase a data storage capability of the disc 120. In other words, a bottom surface of the disc 120 and the upper surface of the hub 134 define a space, and the read/write head can access a portion of the bottom surface of the disc 120 opposite to the upper surface of the hub 134 through the defined space so that data can be recorded on the corresponding portion of the bottom surface of the disc 120.

An outer portion of the clamping zone 122 of the disc 120 can be used as a parking zone in which the read/write head is parked.

The clamping zone 122 of the disc 120 is a region that contacts the head portion of the screw 160 and the supporter 135. In order to prevent the disc 120 from slipping when the supporter 135 of the spindle motor 130 rotates, a surface roughness of the clamping zone 122 of the disc 120 may be made greater than surface roughnesses of other region(s) of the disc 120 (i.e., the data zone 124).

Accordingly, as illustrated in FIG. 5, a plurality of fine protrusions 122a can be formed in the clamping zone 122 of the disc 120. The fine protrusions 122a can be formed by various methods. For example, the fine protrusions 122a can be formed in a shape of a crater by a laser beam machining process. Other methods may also be used.

As described above, friction between the clamping zone 122, the supporter 135, and the head portion of the clamping screw 160 increases due to the fine protrusions 122a formed in the clamping zone 122 of the disc 120. Accordingly, the disc 120 can be fixed to the spindle motor 130 more securely such that the disc 120 does not slip even when an external shock is applied to the hard disk drive.

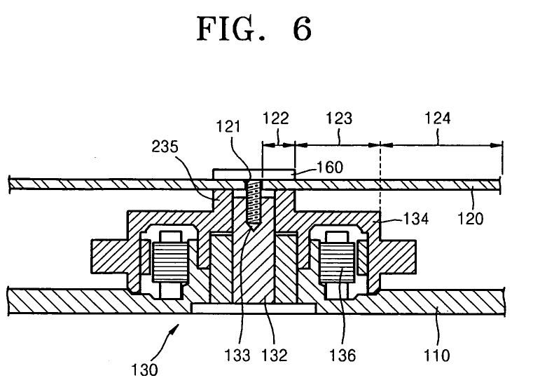

FIG. 6 is a sectional view illustrating a spindle motor assembly according to another embodiment of the present general inventive concept. The spindle motor assembly of FIG. 6 may have some components that are similar to the components of the spindle motor assembly of FIGS. 3 and 4. Accordingly, for illustration purposes, like reference numbers will be used to represent these components.

Referring to FIG. 6, the spindle motor 130 includes a supporter 235 at the upper portion of the shaft 132 to support the disc 120. The supporter 235 has a ring shape that surrounds the shaft 132 and protrudes by the predetermined height above the upper surface of the hub 134. The supporter 235 may be integrally formed with the hub 134. The supporter 235 has an outer diameter smaller than that of the hub 134 and contacts the clamping zone 122 of the disc 120. In this state, the disc 120 is securely fixed to the supporter 235 with the clamping screw 160 fastened to the screw-fastening hole 133, which is formed to extend downward into the shaft 132 by the predetermined depth.

The spindle motor assembly of the present embodiment may have a similar structure and operation as the embodiments of FIGS. 3 and 4. Accordingly, a detailed description of the structure and operation will not be provided.

A parking zone 123, in which to park the read/write head, can be further provided in the disc 120 outside of the clamping zone 122. The data zone 124 can be provided outside of the parking zone 123. That is, the parking zone 123 is provided between the clamping zone 122 and the data zone 124. The parking zone 123 may be provided to correspond to an entire area or a partial area opposite to the upper surface of the hub 134. That is, an outer diameter of the parking zone 123 may be less than or equal to the outer diameter of the hub 134.

Although FIG. 3 illustrates the ramp 146 at which to park the read/write head outside of the disc 120 when the hard disk drive stops operating, it should be understood that the read/write head can instead be parked in the parking zone 123 (see FIG. 6) when the hard disk drive stops operating.

When parking the read/write head on the ramp 146 as illustrated in FIG. 3, data cannot be stored at outermost edge portions of the disc 120 due to a width used to load and unload the read/write head. However, when the parking zone 123 is provided outside the clamping zone 122 of the disc 120, instead of the ramp 146, data can be recorded at the edge portions of the disc 120, thereby increasing a data storage capability.

When the read/write head is parked in the parking zone 123 adjacent to a center of the disc 120 and the disc 120 vibrates due to an external shock applied to the hard disk drive, a vibration amplitude of a portion that is adjacent to the center of the disc 120 is relatively small, thereby reducing damage to the read/write head during an impact between the read/write head and the disc 120.

If both the ramp 146 and the parking zone 123 are included in the hard disk drive, the ramp 146 can be used to park the read/write head when normally stopping an operation of the hard disk drive, and the parking zone 123 can be used to park the read/write head when abnormally stopping the operation of the hard disk drive. When abnormally stopping the operation of the hard disk drive, the read/write head can be parked quickly, since the parking zone 123 is close to where the read/write head records/reproduces data on the disc 120.

As described above, a spindle motor assembly of the embodiments of the present general inventive concept can fix a disc to a spindle motor without using a conventional disc clamp and a spacer. Accordingly, the spindle motor assembly of the embodiments of the present general inventive concept has a simple structure, a number of manufacturing and assembly processes can be reduced, and a possibility of damage to a disc surface due to friction between parts during the assembly process can be reduced. In addition, particles that are typically generated due to friction between parts made of metal are not generated in the spindle motor assembly.

Further, in the embodiments of the present general inventive concept, an outer diameter of a clamping zone of a disc is reduced substantially compared to a clamping zone of a conventional disc so that an area of a data zone is maximized to increase a data storage capability the disc.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A spindle motor assembly usable with a hard disk drive, the assembly comprising:
a data storage disc having a center hole, a clamping zone around the center hole, and a data zone provided at an outer portion of the clamping zone;
a spindle motor to rotate the disc, the spindle motor including a shaft, a hub coupled to an outer circumference of the shaft, and a supporter disposed at an upper surface of the shaft having an outer diameter smaller than the hub and extending a predetermined height above an upper surface of the hub to contact the clamping zone of the disc to support the disc; and
a clamping screw inserted into the center hole of the disc and fastened to the spindle motor to press the clamping zone to fix the disc to the supporter.

2. The spindle motor assembly according to claim 1, wherein the supporter is formed integrally with the shaft.

3. The spindle motor assembly according to claim 2, wherein the supporter includes a screw-fastening hole into which the clamping screw is fastened.

4. The spindle motor assembly according to claim 1, wherein the supporter is formed to have a ring shape to surround the shaft.

5. The spindle motor assembly according to claim 4, wherein the shaft includes a screw-fastening hole into which the clamping screw is fastened at an upper surface thereof.

6. The spindle motor assembly according to claim 1, wherein an outer diameter of the clamping zone of the disc is substantially equal to the outer diameter of the supporter.

7. The spindle motor assembly according to claim 1, wherein an outer diameter of a head portion of the clamping screw is substantially equal to the outer diameter of the supporter.

8. The spindle motor assembly according to claim 1, wherein a surface roughness of the clamping zone of the disc is higher than a surface roughness of the data zone.

9. The spindle motor assembly according to claim 8, wherein the clamping zone of the disc includes a plurality of fine protrusions.

10. The spindle motor assembly according to claim 9, wherein the fine protrusions are formed to have a crater shape by a laser beam machining process.

11. The spindle motor assembly according to claim 1, further comprising:
a read/write head movable with respect to the disc by an actuator to access the data zone adjacent to the clamping zone through a space defined between a bottom surface of the disc and the upper surface of the hub.

12. The spindle motor assembly according to claim 1, wherein the disc further includes a parking zone disposed between the clamping zone and the data zone in which a read/write head is parked.

13. The spindle motor assembly according to claim 12, wherein an outer diameter of the parking zone is less than or equal to the outer diameter hub.

14. A spindle motor assembly usable with a hard disk drive, the assembly comprising:
a base;
a spindle motor including a shaft extending from the base to be rotated with respect to the base;
a disc disposed on an upper portion of the shaft and having a center hole; and
a fastening member to couple the disc to the upper portion of the shaft through the center hole thereof.

15. The spindle motor assembly according to claim 14, further comprising:
a hub disposed around the shaft to be rotated therewith and having an upper surface to define a space with a lower surface of the disc.

16. The spindle motor assembly according to claim 15, wherein the hub includes a portion that protrudes upward along the shaft to contact the disc.

17. The spindle motor assembly according to claim 15, further comprising:
a read/write head movable with respect to the disc into the defined space to read/write data to the lower surface of the disc of the defined space.

18. The spindle motor assembly according to claim 14, wherein the fastening member comprises a clamping screw to be fastened into a screw hole disposed on the upper portion of the shaft such that the clamping screw clamps the disc to the upper portion of the shaft at a clamping zone of the disc.

19. The spindle motor assembly according to claim 14, wherein a circumference of the fastening member is roughly equivalent to a circumference of the upper portion of the shaft.

20. The spindle motor assembly according to claim 14, wherein a portion of the disc on which the fastening member is coupled includes a plurality of protrusions to provide a predetermined roughness.

21. A spindle motor assembly usable with a hard disk drive, the assembly comprising:
a supporter;
a fastening screw coupled to the supporter; and
a disc disposed on the supporter and including a center hole of a predetermined size that corresponds to the fastening screw such that the fastening screw couples the disc to the supporter.

22. The spindle motor assembly according to claim 21, wherein the disc comprises:
a clamping zone disposed around the center hole at which a head portion of the fastening screw clamps the disc to the supporter; and
a data zone disposed around the clamping zone.

23. The spindle motor assembly according to claim 22, wherein the disc further comprises:
a parking zone disposed between the clamping zone and the data zone in which a read/write head is parked when not in operation.

24. A hard disk drive, comprising:
a housing having base and cover portions;
a spindle motor including a shaft extending from the base portion to be rotated with respect to the base portion;
a disc disposed on an upper portion of the shaft and having a center hole; and
a fastening member to couple the disc to the upper portion of the shaft through the center hole thereof.

25. The hard disk drive according to claim 24, further comprising:
a read/write head to read/write data to a surface of the disc; and
an actuator to move the read/write head along the surface of the disc to and from a portion of the disc at which the fastening member is disposed.

26. The hard disk drive according to claim 25, wherein the disc comprises:
a clamping zone disposed between the upper portion of the shaft and a head portion of the fastening member; and
a parking zone disposed around the clamping zone such that the actuator parks the read/write head in the parking zone when the hard disk drive abnormally stops operation.

27. The hard disk drive according to claim 25, further comprising:
a rotating hub disposed on the base portion around the shaft to be rotatable therewith such that the shaft protrudes a predetermined height above an upper portion of the hub, and the upper portion of the hub and a lower portion of the disc define a space into which the read/write head is movable.
